(19) United States
(12) Patent Application Publication
(10) Pub. No.: US 2012/0058774 A1
(43) Pub. Date: Mar. 8, 2012

(54) APPARATUS AND METHOD FOR DISPLAYING AUGMENTED REALITY INFORMATION

(75) Inventor: Dong-Su KIM, Bucheon-si (KR)

(73) Assignee: PANTECH CO., LTD., Seoul (KR)

(21) Appl. No.: 13/008,541

(22) Filed: Jan. 18, 2011

(30) Foreign Application Priority Data
Sep. 2, 2010 (KR) 10-2010-0086138

(51) Int. Cl. H04W 64/00; H04W 88/02

(52) U.S. Cl. 455/456.1; 455/566

(57) ABSTRACT

An apparatus and method for displaying augmented reality (AR) information on a terminal according to authorization for use of AR information provided from an AR system. The method includes recognizing a current location of the terminal; receiving authorization information of AR information receivable at the recognized current location; determining whether the AR information is available with reference to the authorization information for the AR information; and displaying the receivable AR information according to the determination result. Accordingly, the terminal recognizes its current location, determines the availability of AR information receivable at the recognized location, receives available AR information from the AR system according to the determination result, and displays the received available AR information in a window on a display of the terminal.

### CROSS-REFERENCE TO RELATED APPLICATION

This application claims priority from and the benefit under 35 U.S.C. §119(a) of Korean Patent Application No. 10-2010-0086138, filed on Sep. 2, 2010, the disclosure of which is incorporated herein by reference for all purposes.

### BACKGROUND

1. Field

The following description relates to an apparatus and method for displaying augmented reality (AR) information.

2. Discussion of the Background

Augmented reality (AR) refers to a computer graphic technique that combines virtual objects or information with a real-world environment to display the virtual elements as if they were present in the real environment.

Unlike a general virtual reality technology, which provides only virtual objects in a virtual space, AR technology provides a view of reality which is blended with virtual objects, thereby capable of providing a better sense of reality and providing supplementary information, which is difficult to obtain in reality.

With the recent improvement of computing performance of mobile devices, such as mobile phones, personal digital assistants (PDAs), and ultra mobile personal computers (UMPCs), and development of wireless communication apparatuses, various AR service have been available.

For example, an object of a real environment that is photographed by a camera of a mobile phone is merged with property information associated with the photographed object, and a resultant image is output to a window displayed on a display. The general AR service provides property information which is provided in the augmented reality to all users equally, and consequently, security issues occur.

In addition, in the general AR service, as a technique for AR service has been developed and the amount of information to be dealt with has increased, property information to be provided to a user's mobile phone has also increased in amount. The general AR service provides a mobile phone with all information available at the current location of the mobile phone and displays property information of all objects in a window on a display of the mobile phone. Hence, information unnecessary to the user is provided, which hinders the user from finding and utilizing desired information. To solve the above problems, the general AR service filters information to be used by a user, but it takes substantial amount of time to extract information requested by the user from a variety of information and transmit the extracted information to a user's mobile phone, and a server may be overloaded while executing such operations.

### SUMMARY

Exemplary embodiments of the present invention provide a multiprocessor apparatus and method for increasing a parallel processing speed.

Exemplary embodiments of the present invention provide a multiprocessor apparatus and method for increasing a speed of parallel processing data having a multi-layer structure.

Additional features of the invention will be set forth in the description which follows, and in part will be apparent from the description, or may be learned by practice of the invention.

An exemplary embodiment provides a method for displaying augmented reality (AR) information through a terminal, the method including: recognizing a current location of the terminal; receiving authorization information of AR information receivable at the recognized current location; determining whether the AR information is available with reference to the authorization information for the AR information; and displaying the receivable AR information according to the determination result.

An exemplary embodiment provides a terminal, including a communication unit to perform data communication with an AR system; and a control unit to receive authorization information of AR information receivable at a current location from the AR system through the communication unit, to determine whether the AR information is available with reference to the received authorization information of the AR information, and display the AR information.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart of a method for displaying augmented reality (AR) information according to an exemplary embodiment.

FIG. 2 is a flowchart of a method for checking the availability of AR information according to an exemplary embodiment.

FIG. 3 is a diagram of a terminal according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art.

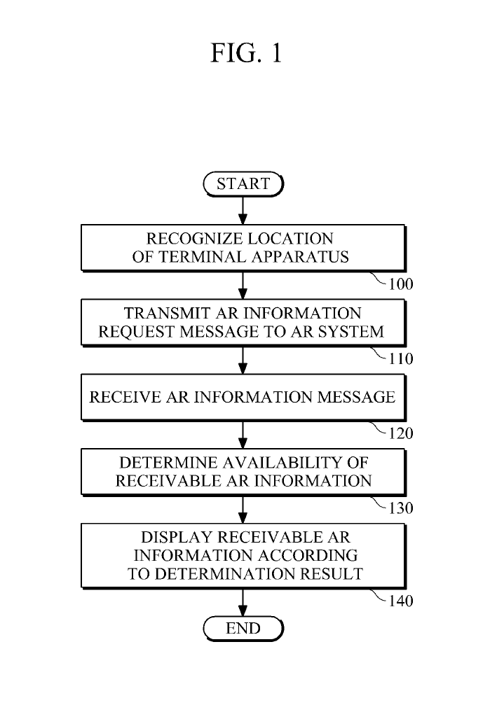

FIG. 1 is a flowchart of a method for displaying augmented reality (AR) information according to an exemplary embodiment. Referring to FIG. 1, a terminal recognizes a current location of the terminal at regular intervals to receive augmented reality (AR) information from an AR system in operation 100. The terminal may determine the current location using at least one of methods as mentioned below. For example, the terminal may have a global positioning system (GPS) receiver equipped therein, and may determine the current location by receiving GPS information from an external device through the GPS receiver. For another example, the terminal may have a sensor, such as an acceleration sensor, accelerometer, or a G sensor inside, and may recognize the current location thereof by obtaining azimuth information detected by the included sensor.

For another example, the terminal may use identification information of the terminal, which is stored in the AR system to which the terminal is connected over a network to determine the current location. In this example, the AR system stores AR information that includes pieces of information of a plurality of objects and pieces of property information of each object according to the locations of the object. In addition, the AR system may store identification information assigned to each of a plurality of registered and stored terminals, and may relay apparatus identification information containing address information of a relay apparatus through which data communication may be performed. Accordingly, the terminal may be allowed to determine the current location of the terminal based on the identification information assigned by the AR system.

If the current location of the terminal is determined, the terminal generates an AR information request message and transmits the generated message to the AR system in operation 110. The AR information request message may include location information on the determined location and terminal information on the terminal. Hence, the AR system obtains AR information related to the location information included in the AR information request message received from the terminal with reference to the stored pieces of AR information corresponding to locations of each object. In this example, the AR information may be information related to the object to be displayed in a window on a display of the terminal at the current position, or the AR information may be information that can be provided by the terminal at the current position.

The AR system that has obtained the AR information request message generates an AR information message that includes authorization information for authorizing use of the obtained AR information. If the AR information message is generated, the AR system transmits the generated AR information message to the corresponding terminal with reference to the terminal information included in the received AR information request message. Accordingly, in operation 120, the terminal receives, from the AR system, the AR information message containing the authorization information for authorizing use of the AR information that is receivable at the currently recognized location of the terminal.

In response to receiving the AR information message, in operation 130, the terminal determines whether the AR information receivable at the current location is available with reference to the authorization information for authorizing use of the AR information included in the received AR information message. Specifically, the terminal checks whether the AR information receivable at the current location is available to be used by all users or one or more specific or designated users, and according to the check result, receives the AR information from the AR system and displays the AR information in a window of a display in operation 140.

If the AR information receivable at the current location is available to be used by all users, the terminal may generate summary information of the AR information received from the AR system and may display the summary information in a window on a display of the terminal. However, aspects are not limited thereto such that, if the AR information receivable at the current location is available to be used by all users, the terminal may receive the AR information receivable at the current location from the AR system. In such case, the terminal may make a sound to notify of the AR information being received or being available for receipt from the AR system.

Further, the terminal that has received the AR information available to all users may display a part or portion of the received AR information. If pieces of received AR information are received which are available to all users at the current location, the terminal may display a summary of the pieces of AR information in the window on the display of the terminal, and thus the user can easily select desired AR information in the window on the display of the terminal and use a service related to the selected AR information.

If AR information receivable at a current location is available to be used by a designated user, the terminal may display the AR information available to a designated user to be distinguishable from other AR information displayed in the window on the display of the terminal. For example, if the terminal receives the AR information available only to a designated user, and the terminal may process the received AR information to be displayed larger than any other AR information in the window on the display of the terminal or be displayed full-screen. Accordingly, the user may confirm the receipt of the AR information available only to him or her even if pieces of AR information are displayed in the window on the display of the terminal.

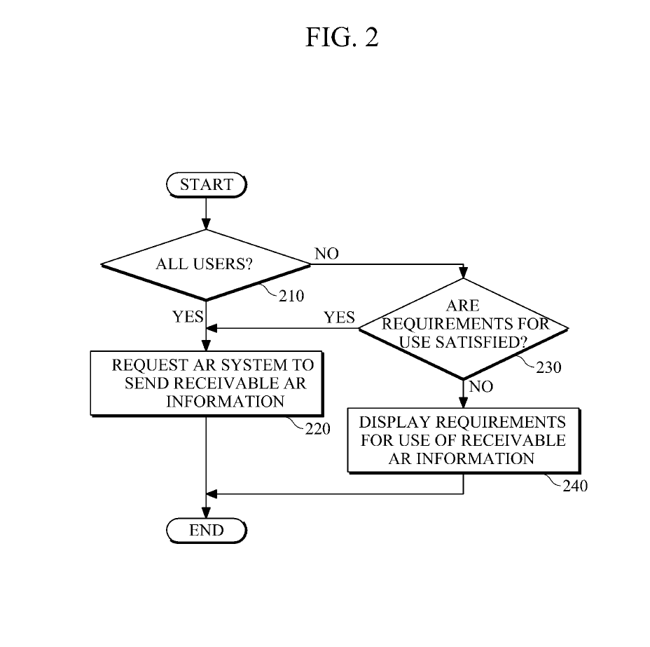

Hereinafter, an example of a method for checking, at the terminal, the availability of AR information receivable at a current location based on authorization information for authorizing use of the AR information included in an AR information message will be described with reference to FIG. 2.

FIG. 2 is a flowchart of a method for checking the availability of AR information according to an exemplary embodiment. Referring to FIG. 2, the terminal receives an AR information message about AR information receivable at a current location from the AR system. The AR information message may include authorization information for checking the availability of the AR information receivable at a current location. In operation 210, terminal determines whether the receivable AR information is available to all users or only to a designated user based on the authorization information included in the AR information message received from the AR system. If the determination result indicates that the receivable AR information is available to all users, the terminal requests the AR system to send corresponding AR information in operation 220. In response to the request, the AR system sends the AR information to the terminal, and the terminal may make a sound to inform of the receipt of the AR information or display a part of an information message included in the received AR information in the window on the display of the terminal as described above.

If the check result indicates that the receivable AR information is available to a designated user in operation 210, the terminal determines whether the authorization information included in the received AR information message is identical to authorization information that is previously stored in an inherent information storage unit of the terminal in operation 230. The inherent information may be information for checking the availability of the AR information to a corresponding terminal, and may include at least one piece of user information, such as resident registration number, date of birth, user name, phone number, email address, and group ID information. For example, the authorization information for authorizing use of AR information, which is included in the AR information message, may be a phone number of the terminal that is to use the corresponding AR information. In this case, the terminal may check whether the phone number, as the authorization information, is identical to a phone number previously stored in the inherent information storage unit of the terminal.

However, aspects are not limited thereto such that the authorization information included in the AR information message may be information on a group including the terminal available to use the corresponding AR information. For example, an AR information provider for a particular location or object maybe a telecommunication service company, and the telecommunication service company may generate AR information for offering, for example, a free coffee voucher only to subscribers of the telecommunication service company, and register the generated AR information in the AR system. In this case, if the terminal receives AR information message related to the free coffee voucher for the subscribers of the telecommunication service company from the AR system, the terminal may check whether the terminal can use the free coffee voucher with reference to authorization information included in the received AR information message. Specifically, the terminal may determine whether it can be provided with the free coffee voucher by checking information on a group ID of a telecommunication service provider, which is stored in the inherent information storage unit. And, if it is determined that the free coffee voucher is available to the terminal, the terminal may request the AR system to send AR information related to the free coffee voucher. Then, the terminal may receive the requested AR information from the AR system, and may display the received AR information in the window on the display of the terminal. The terminal may display the AR information available to designated users larger than the other AR information, i.e., AR information available to all users, displayed in the window on the display of the terminal or may display the AR information available to designated users as full-screen so as to distinguish the received AR information from the other displayed AR information.

If it is determined that the authorization information included in the received AR information message is not identical to the authorization information stored in the inherent information storage unit of the terminal in operation 230, the terminal displays information of requirements for using the AR information in the window on the display of the terminal in response to a user's request in operation 240.

For example, an AR information provider for a particular location or object may be a family restaurant owner, and the family restaurant owner may generate AR information for offering a free meal voucher to members joining a website of the family restaurant, and registers the generated AR information in the AR system. In this case, if receiving AR information message related to an event for members who have joined the website of the family restaurant from the AR system, the terminal checks whether the terminal can be provided with the free meal voucher with reference to authorization information included in the received AR information message. That is, the terminal checks whether information on membership IDs stored in the inherent information storage unit satisfies the authorization information associated with the free meal voucher. If the membership ID information does not satisfy the authorization information, the terminal displays the authorization information related to the use of a free meal voucher in the window on the display of the terminal. Then, the user is enabled to access and join the website of the family restaurant through the terminal, thereby being capable of receiving the AR information related to the free meal voucher offered by the family restaurant from the AR system. As the result, the user can use the free meal voucher.

If it is determined that the authorization information included in the received AR information message is identical to the authorization information stored in the inherent information storage unit of the terminal in operation 230, the terminal requests the AR system to send corresponding AR information available to designated users in operation 220.

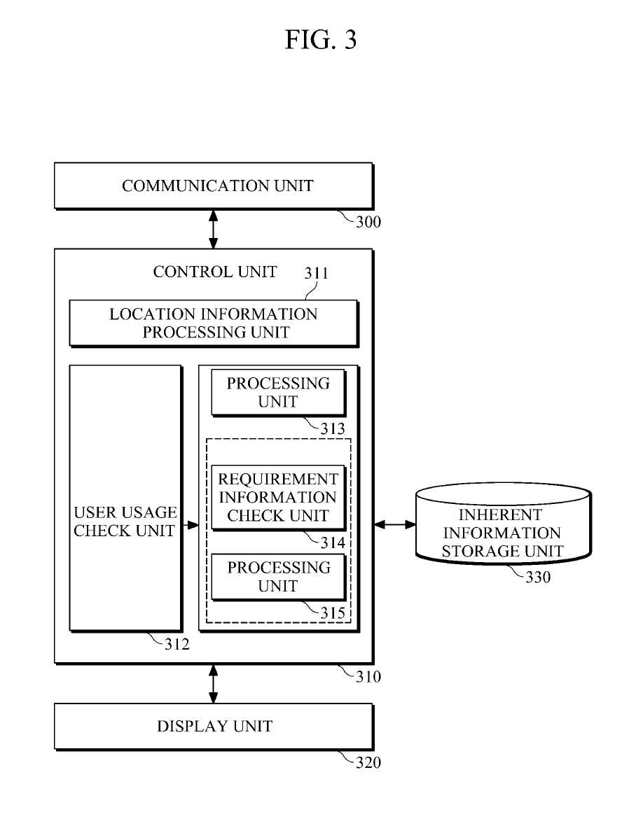

Hereinafter, an example of a configuration of a terminal capable of displaying AR information in an augmented reality will be described below. FIG. 3 is a diagram of a terminal according to an exemplary embodiment.

The terminal according to exemplary embodiments of the present invention may be a mobile terminal, smartphone, cellular phone, laptop computer, personal computer, tablet computer, or the like. As shown in FIG. 3, the terminal may include a communication unit 300, a control unit 310, and a display unit 320. The terminal may use the communication unit 300 to perform data communication with an AR system connected over a network. The control unit 310 may receive AR information message including AR information that is receivable at a current location from the AR system through the communication unit 300. The control unit 310 may determine the availability of the receivable AR information of the AR information message, and may control the display unit 320 to display the received AR information in a window on a display of the terminal. The control unit 310 may include a location information processing unit 311, a user usage check unit 312, a processing unit 313 for processing AR information available to all users, a requirement information check unit 314, and a processing unit 315 for processing AR information available to designated users.

The location information processing unit 311 may recognize a current location of the terminal, and may transmit the location information to the AR system through the communication unit 300. The location information processing unit 311 may recognize a location of the terminal based on GPS information received from an external device through the communication unit 300, or based on azimuth information obtained by a sensor, such as an acceleration sensor, an accelerometer, or a G sensor. In addition, the location information processing unit 311 may recognize the current location of the terminal using identification information of terminals registered and stored in the AR system. The AR system may store a plurality of objects, and pieces of AR information, including information of properties of each object at different locations. In addition, the AR system may store pieces of identification information assigned to the respective registered and stored terminals and relay apparatus identification information that includes address information of a relay apparatus for data communication with the terminals. Accordingly, the location information processing unit 311 may recognize a current location of the terminal using the identification information assigned by the AR system.

The location information processing unit 311 may transmit location information about the recognized location of the terminal to the AR system. At this time, the location information processing unit 311 may transmit to the AR system an AR information request message that includes the location information and terminal information stored in the inherent information storage unit 330, which will be described later. Then, the AR system may acquire AR information related to the location information included in the received AR information request message, and transmit an AR information message related to the acquired AR information to the terminal with reference to the terminal information. The AR information may be AR information in relation with an object displayed in the window on the display of the terminal, or AR information that is available to the terminal at the current location.

In response to receiving the AR information from the AR system, the user usage check unit 312 may check whether receivable AR information is available to all users or to a designated user with reference to authorization information for authorizing use of the AR information, which is contained in the AR information message received from the AR system. If the check result indicates that the receivable AR information is available to all users, the processing unit 313 for processing AR information available to all users may generate summary information of the AR information received from the AR system, and display the generated summary information in the window on the display of the display unit 320. The processing unit 313 may output a sound to notify of reception of the AR information from the AR system, or may display a part of the received AR information in the window on the display of the display unit 320. Accordingly, a summary of a plurality of AR information available to all users may be displayed in the window on the display of the terminal, and thus the user can find desired AR information fast and easily.

The user usage check unit 312 may determine that the receivable AR information is available to a designated user, and the requirement information check unit 314 may check whether authorization information contained in the AR information message is identical to the inherent information stored in the inherent information storage unit 330. Here, the inherent information stored in the inherent information storage unit 330 may be information for checking the availability of the AR information to the terminal, and may include at least one piece of user information, such as resident registration number, date of birth, user name, phone number, email address, and group ID information. When the requirement information check unit 314 determines that the inherent information stored in the inherent information storage unit 330 is identical to the authorization information contained in the AR information message, the processing unit 315 for processing AR information available to a designated user may request the AR system to transmit the corresponding AR information, and receive the requested AR information, and the display unit 320 may display the received AR information in the window on the display. The processing unit 315 may process the AR information available to a designated user received from the AR system to be displayed distinguishable from the other AR information, i.e., the AR information available to all users, currently displayed in the window on the display.

If receiving the AR information related to the designated user, the processing unit 315 may process the received AR information to be displayed larger than other AR information. Hence, the user may recognize the AR information available only to the user from among a plurality of AR information displayed in the window on the display.

If the requirement information check unit 313 determines that the inherent information stored in the inherent information storage unit 330 is not identical to the authorization information contained in the AR information message, the processing unit 315 may display information of requirement information for using the AR information in the window on the display with reference to the authorization information contained in the AR information message. Consequently, the user is enabled to input information for use of the AR information with reference to the displayed information of requirements. The requirement information check unit 313 may check whether the information input by the user is identical to the authorization information contained in the AR information message, and if the information input by the user and the authorization information contained in the AR information are identical to each other, the processing unit 315 may receive the corresponding AR information from the AR system. Thereafter, the processing unit 315 may process the received AR information to be displayed distinguishable from the other AR information displayed in the window on the display.

The current exemplary embodiments can be implemented as computer readable codes in a computer readable record medium. Codes and code segments constituting the computer program can be easily inferred by a skilled computer programmer in the art. The computer readable record medium includes all types of record media in which computer readable data are stored. Examples of the computer readable record medium include a ROM, a RAM, a CD-ROM, a magnetic tape, a floppy disk, and an optical data storage. In addition, the computer readable record medium may be distributed to computer systems over a network, in which computer readable codes may be stored and executed in a distributed manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for displaying augmented reality (AR) information through a terminal, the method comprising:
recognizing a current location of the terminal;
receiving authorization information of AR information receivable at the recognized current location;
determining whether the AR information is available with reference to the authorization information for the AR information; and
displaying the receivable AR information according to the determination result.

2. The method of claim 1, wherein the recognizing of the current location of the terminal comprises:
recognizing the current location of the terminal based on global positioning system (GPS) information acquired by a GPS receiver of the terminal.

3. The method of claim 1, wherein the recognizing of the current location of the terminal comprises:
obtaining an azimuth of the terminal.

4. The method of claim 1, wherein the recognizing of the current location of the terminal comprises:
recognizing the current location of the terminal using identification information of the terminal, which is stored in an AR system connected to the terminal over a network.

5. The method of claim 1, wherein the determining of whether the AR information is available comprises:
checking whether the receivable AR information is available to all users or available to a designated user with reference to information of requirements for use, which is included in the received authorization information of the AR information; and
requesting the AR system to transmit the receivable AR information if the checking result indicates that the AR information is available to all users.

6. The method of claim 5, wherein the displaying of the receivable AR information comprises:
generating summary information of the AR information received from the AR system in response to the request; and
displaying the summary information.

7. The method of claim 5, wherein the determining of whether the AR information is available comprises:
determining whether the information of requirements for use included in the authorization information of the AR information is identical to inherent information stored in the terminal if the checking result indicates that the receivable AR information is available to a designated user; and
requesting the AR system to transmit the receivable AR information if the determination result indicates that the information of requirements for use is identical to the authorization information of the AR information.

8. The method of claim 7, wherein the inherent information stored in the terminal comprises at least one of user information, telephone number, email information, and group ID information.

9. The method of claim 7, wherein the displaying of the receivable AR information comprises:
displaying the AR information, which has been received from the AR system in response to the request, to be distinguishable from other AR information displayed in a window on a display.

10. The method of claim 7, wherein the determining of whether the AR information is available comprises:
if the determination result indicates that the information of the requirements included in the authorization information of the AR information is not identical to the inherent information stored in the terminal, displaying information of requirements for use of the receivable AR information with reference to the information of requirements included in the authorization information of the AR information.

11. A terminal, comprising:
a communication unit to perform data communication with an AR system; and
a control unit to receive authorization information of AR information receivable at a current location from the AR system through the communication unit, to determine whether the AR information is available with reference to the received authorization information of the AR information, and display the AR information.

12. The terminal of claim 11, wherein the control unit further comprises:
a location information processing unit to recognize a current location of the terminal and to transmit location information on the current location to the AR system through the communication unit,
wherein the location information processing unit obtains the location information using at least one of global positioning system (GPS) information, azimuth information received from an external device, and identification information of the terminal, which is registered and stored in the AR system.

13. The terminal of claim 12, wherein the control unit further comprises:
a user usage check unit to check whether the receivable AR information is available to all users or to a designated user with reference to information of requirements for use included in the authorization information of the AR information received from the AR system; and
a first processing unit to receive the receivable AR information from the AR system, to generate summary information of the received AR information, and to display the summary information on a screen if the determination result indicates that the receivable AR information is available to all users.

14. The terminal of claim 13, further comprising:
a storage unit to store inherent information of the terminal comprising at least one of user information, phone number, email information, and group ID information,
wherein the control unit further comprises:
a requirement information check unit to check whether the information of requirements for use included in the received authorization information of the AR information is identical to the inherent information stored in the storage unit if the check result indicates that the AR information is available to a designated user, and
a second processing unit to receive the receivable AR information from the AR system and to display the received AR information to be distinguishable from other AR information displayed in the window on the display if the check result indicates that the information of requirements is identical to the inherent information.

15. The terminal of claim 14, wherein the processing unit displays information of requirements for use of the receivable AR information with reference to the information of requirements for use included in the received authorization information of the AR information if the check result indicates that the information of requirements is not identical to the inherent information.
